(19) United States
(12) Patent Application Publication
(10) Pub. No.: US 2009/0285397 A1
(43) Pub. Date: Nov. 19, 2009

(54) MEDIA PROCESSOR AND RECORDING MEDIUM CONTROL METHOD

(76) Inventors: Koichi Iwamori, Shiga (JP); Kenichi Isoyama, Kyoto (JP)

Correspondence Address: MCDERMOTT WILL & EMERY LLP, 600 13TH STREET, NW, WASHINGTON, DC, 20005-3096, US

(21) Appl. No.: 12/412,815

(22) Filed: Mar. 27, 2009

(30) Foreign Application Priority Data
May 19, 2008 (JP) 2008-131134

(51) Int. Cl. H04L 9/06

(52) U.S. Cl. 380/277

(57) ABSTRACT

In a media processor for reading data from or writing data into a recording medium with which mutual authentication has been performed, an authentication processing section generates key information of the recording medium and obtains authentication information of attributes of data stored in the recording medium. An identification information retrieval section obtains identification information of the recording medium. A control section associates the key information, the authentication information, and the identification information with each other to store them in a storage section. In a case in which the recording medium is changed to anther one, if the identification information of the another recording medium matches the identification information stored in the storage section, the media processor uses the key information and the authentication information stored in the storage section.

### CROSS REFERENCE TO RELATED APPLICATION

The disclosure of Japanese Patent Application No. 2008-131134 filed on May 19, 2008 including specification, drawings and claims is incorporated herein by reference in its entirety.

### BACKGROUND OF THE INVENTION

The present disclosure relates to a media processor and a recording medium control method for reading data from and writing data into a mutually authenticated recording medium.

In recent years, as electronic devices such as cell phones and media players, many products capable of media processing, such as playback of moving image contents and audio contents stored in SD memory cards or other recording media, have been available on the market. Many of such contents are encrypted before they are stored in recording media so as to protect the copyrights thereof. For example, according to the SD-Video and SD-Audio standards, contents are encrypted and then stored in SD memory cards to protect their copyrights. To decrypt such encrypted contents, mutual authentication needs to be performed with SD memory cards.

In a conventional media processor, key information, which is generated when mutual authentication is performed with recording media, and authentication information are retained in a memory to thereby achieve a reduction both in the number of mutual authentications with the recording media and in power consumption (see Japanese Laid-Open Publication No. 2008-54090, for example). In another conventional media processor, pieces of information which are related to content data recorded on recording media, and pieces of identification information of the recording media are associated with each other and stored, thereby facilitating control of the contents in the recording media (see Japanese Laid-Open Publication No. 2004-62916, for example).

### SUMMARY OF THE INVENTION

In general, when an electronic device accesses an external recording medium, the electronic device and the recording medium mutually authenticate each other. In particular, in battery-powered electronic devices such as cell phones, power consumption can be lowered by supplying power only to an internal circuit thereof in which authentication information, etc. are retained while data is not read from or written into a recording medium.

However, if the recording medium is changed, to access the recording medium, the electronic device needs to delete authentication information retained therein and then perform mutual authentication again. Thus, even a recording medium that has been once authenticated before the recording medium is changed must be mutually authenticated again after mutual authentication with another recording medium is performed. The time required for mutual authentication is increased as the number of files retained in the recording medium is increased. In this way, in battery-powered electronic devices, low power consumption is achievable at the expense of usability.

The presently disclosed device and method may be advantageous for reducing the number of mutual authentications with the recording medium while low power consumption is achieved, even when a recording medium is changed.

An example media processor for reading data from or writing data into a recording medium with which mutual authentication has been performed includes: an authentication processing section for generating key information of the recording medium and obtaining authentication information of attributes of data stored in the recording medium; an identification information retrieval section for obtaining identification information of the recording medium; a storage section for storing various kinds of information; and a control section for associating the key information, the authentication information, and the identification information with each other to store them in the storage section. In a case in which the recording medium is changed to another one, if the identification information of the another recording medium matches the identification information stored in the storage section, the key information and the authentication information stored in the storage section are used.

Also, an example recording medium control method for reading data from or writing data into a recording medium with which mutual authentication has been performed includes: a step of generating key information of the recording medium; a step of obtaining authentication information of attributes of data stored in the recording medium; a step of obtaining identification information of the recording medium; and a step of associating the key information, the authentication information, and the identification information with each other to store them. In a case in which the recording medium is changed to another one, if the identification information of the another recording medium matches the stored identification information, the stored key information and the stored authentication information are used.

As set forth above, according to the example device and method, in a system in which authentication with recording media is necessary, if key information and authentication information on a recording medium that has been changed are retained, authentication processing does not have to be performed again for that recording medium. It is thus possible to reduce the number of mutual authentications with recording media, while achieving low power consumption.

### BRIEF DESCRIPTION OF THE DRAWINGS

FIG. 1 is a block diagram of a media processor according to a first embodiment.

FIG. 2 shows information stored in a storage section in the media processor of the first embodiment.

FIG. 3 is a flowchart for the media processor of the first embodiment.

FIG. 4 is a block diagram of a media processor according to a second embodiment.

FIG. 5 shows information stored in a storage section in the media processor of the second embodiment.

FIG. 6 is a flowchart for the media processor of the second embodiment.

### DETAILED DESCRIPTION OF THE INVENTION

Hereinafter, the preferred embodiments of the present invention will be described with reference to the accompanying drawings. In the following embodiments, a description will be made of an example in which mutual authentication is performed with an SD memory card as a recording medium, and contents encrypted in accordance with the CPRM (Content Protection for Recordable Media), which is a standard for copyright protection, are read from the SD memory card to perform audio playback of the contents.

### First Embodiment

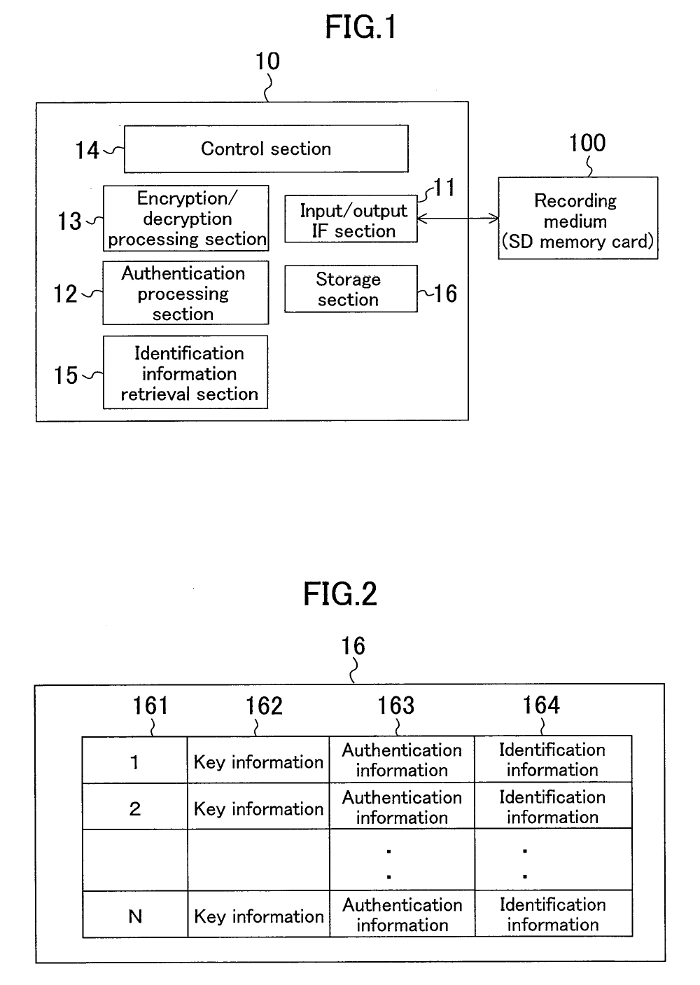

FIG. 1 is a block diagram of a media processor according to a first embodiment. The media processor 10 of this embodiment includes an input/output IF section 11, an authentication processing section 12, an encryption/decryption processing section 13, a control section 14, an identification information retrieval section 15, and a storage section 16.

The input/output IF section 11 is an interface with an SD memory card 100. The authentication processing section 12 performs mutual authentication with the SD memory card 100 and generates key information specific to the SD memory card 100 by using information obtained by the input/output IF section 11 from the SD memory card 100.

The encryption/decryption processing section 13 accesses a secure area in the SD memory card 100 by using the key information generated by the authentication processing section 12 and decrypts encrypted data read from the SD memory card 100 into plaintext data or encrypts plaintext data by using a content key stored in the secure area.

The control section 14 controls reading of data from the SD memory card 100 and writing of data into the SD memory card 100. The control section 14 also controls power supply to the input/output IF section 11, the authentication processing section 12, the identification information retrieval section 15, and the encryption/decryption processing section 13. While data is not read from or written into the SD memory card 100, the control section 14 performs control so that power is supplied only to the storage section 16 and no power is supplied to the input/output IF section 11, the authentication processing section 12, the identification information retrieval section 15, and the encryption/decryption processing section 13.

The key information generated by the authentication processing section 12 varies for each SD memory card that the media processor 10 accesses, but also varies depending on the attributes of data (for example, audio data and video data) read from or written into the SD memory card 100. The control section 14 stores in the storage section 16 the attributes of data as authentication information together with the key information generated by the authentication processing section 12.

The control section 14 stores the key information generated by the authentication processing section 12, the attributes of data (the authentication information), and identification information obtained by the identification information retrieval section 15 in separate different areas in the storage section 16.

The identification information retrieval section 15 obtains the identification information of the SD memory card 100 through the input/output IF section 11. The encryption/decryption processing section 13 decrypts encrypted data or encrypts plaintext data by using the key information generated through authentication processing.

FIG. 2 shows information stored in the storage section 16. The storage section 16 includes a table number area 161, a key information storage area 162, an authentication information storage area 163, and an identification information storage area 164. In the key information storage area 162, each piece of key information generated through mutual authentication processing is stored. In the authentication information storage area 163, each piece of key information storage location information, which indicates the location in which a corresponding piece of key information is stored, and each piece of authentication type information, which indicates the attribute of the corresponding piece of key information, are stored as authentication information. In the identification information storage area 164, each piece of identification information of each SD memory card 100 is stored. These pieces of information are associated with a table number in the table number area 161 and thereby stored as one set of information. In the storage section 16, multiple sets of such information can be stored.

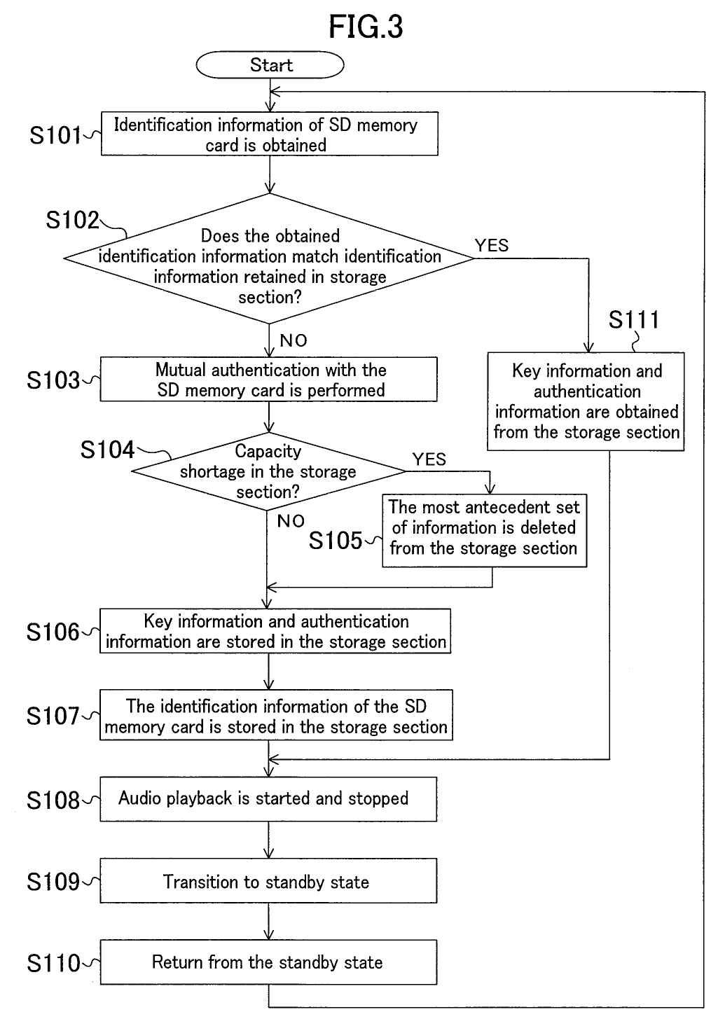

Operation of the media processor 10 will be described below with reference to a flowchart shown in FIG. 3.

First, a description will be made of a procedure for performing audio playback of encrypted contents stored in an SD memory card 100 that has not yet been mutually authenticated in media playback equipment.

In Step S101, the identification information retrieval section 15 obtains identification information of the SD memory card 100 through the input/output IF section 11. In Step S102, the control section 14 confirms whether the identification information obtained in Step S101 matches identification information retained in the identification information storage area 164 in the storage section 16. In this case, since the SD memory card 100 has not yet been mutually authenticated, there is no matching identification information, and the process proceeds to Step S103.

In Step S103, mutual authentication between the media processor 10 and the SD memory card 100 is performed, and the authentication processing section 12 generates key information specific to the SD memory card 100. In Step S104, the control section 14 checks whether there are available areas in the key information storage area 162, in the authentication information storage area 163, and in the identification information storage area 164 in the storage section 16 in which a set of information on the new SD memory card 100 can be stored. If there are no areas available, the control section 14 deletes in Step S105 one of the multiple sets of information stored in the storage section 16 that is associated with the most antecedent table number.

In Step S106, the control section 14 stores the key information generated in Step S103 in the key information storage area 162 in the storage section 16. The control section 14 also stores key information storage location information that indicates the location of the storage of the key information, and authentication type information that indicates the attribute of the key information in the authentication information storage area 163 in the storage section 16 as authentication information.

In Step S107, the control section 14 stores the identification information of the SD memory card 100 obtained in Step S101 in the identification information storage area 164 in the storage section 16. At this time, the control section 14 assigns a table number which associates the key information, the authentication information, and the identification information with one another. In order to control multiple sets of information in the storage section 16, after assigning the table number, the control section 14 increments the table number so that a unique value is assigned to each set of information.

In Step S108, the encryption/decryption processing section 13 accesses a secure area in the SD memory card 100 by using the key information and the authentication information and decrypts encrypted contents into plaintext data by using a content key stored in the secure area. Audio playback of the decrypted plaintext data is performed on the media processor 10, and then the playback is stopped.

In Step S109, when the audio playback of the encrypted contents stored in the SD memory card 100 becomes unnecessary, the media processor 10 goes to a standby state. In response to this, the control section 14 performs control so that power is supplied only to the storage section 16 and no power is supplied to the input/output IF section 11, the authentication processing section 12, the identification information retrieval section 15, and the encryption/decryption processing section 13. During the standby state, the SD memory card 100 is changed by the user if necessary. Thereafter, in Step S110, when audio playback of encrypted contents stored in the SD memory card 100 is performed again, the media processor 10 returns from the standby state and goes back to Step S101.

Next, a description will be made of a procedure for performing audio playback of encrypted contents stored in an SD memory card 100 that has been mutually authenticated before.

In Step S101, the identification information retrieval section 15 obtains identification information of the SD memory card 100 through the input/output IF section 11. In Step S102, the control section 14 confirms whether the identification information obtained in Step S101 matches identification information retained in the identification information storage area 164 in the storage section 16. In this case, the SD memory card 100 has been mutually authenticated before, there is matching identification information, and the process proceeds to Step S111.

In Step S111, the control section 14 obtains a table number assigned to the matching identification information in the identification information storage area 164 in the storage section 16, and obtains key information and authentication information corresponding to that table number from the key information storage area 162 and the authentication information storage area 163. Thereafter, the process proceeds to Step S108, thereby omitting mutual authentication processing.

As described above, in the media processor 10 according to this embodiment, the storage section 16 includes the three areas, i.e., the key information storage area 162, the authentication information storage area 163, and the identification information storage area 164, and thus can retain pieces of identification information of multiple SD memory cards 100 and multiple different authentication states. Therefore, to perform audio playback of encrypted contents stored in the SD memory card 100 with which the media processor 10 has performed mutual authentication before, the media processor 10 does not need to perform authentication again.

Furthermore, it is possible to delete the pieces of identification information and the multiple different authentication states retained in the storage section 16. This prevents overflow of the storage section 16 even if the storage section 16 has a limited capacity.

Moreover, while the media processor 10 does not perform audio playback of encrypted contents stored in the SD memory card 100, the control section 14 performs control so that power is supplied only to the storage section 16 and no power is supplied to the input/output IF section 11, the authentication processing section 12, the identification information retrieval section 15, and the encryption/decryption processing section 13. In a case in which the storage section 16 is constructed of an SRAM, if power supply is cut off, all of the information stored in the key information storage area 162, in the authentication information storage area 163, and in the identification information storage area 164 will be deleted. However, in the media processor 10 of this embodiment, since power is constantly supplied to the storage section 16, the information stored in the storage section 16 is not deleted.

Accordingly, it is possible to reduce the number of mutual authentications with the SD memory card 100, while achieving low power consumption.

### Second Embodiment

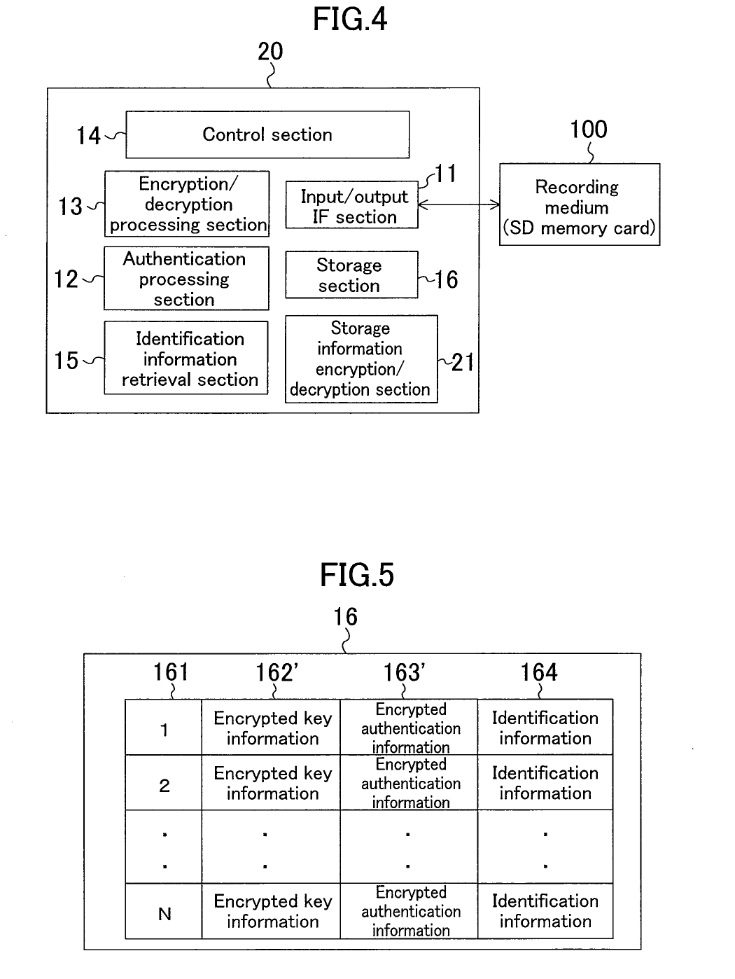

FIG. 4 is a block diagram of a media processor according to a second embodiment. The media processor 20 of this embodiment is obtained by adding a storage information encryption/decryption section 21 to the media processor 10 of the first embodiment. This embodiment will be described only in terms of its differences from the first embodiment.

The storage information encryption/decryption section 21 encrypts information that is to be stored in a storage section 16 and decrypts encrypted information stored in the storage section 16. A control section 14 encrypts key information generated by an authentication processing section 12, the attributes of data (authentication information), and identification information obtained by an identification information retrieval section 15, and stores the encrypted key information, the encrypted attributes of data and the encrypted identification information in separate different areas in the storage section 16.

FIG. 5 shows information stored in the storage section 16. The storage section 16 includes a table number area 161, an encrypted key information storage area 162′, an encrypted authentication information storage area 163′, and an identification information storage area 164. In the encrypted key information storage area 162′, each piece of key information generated through mutual authentication processing is stored after encrypted by the storage information encryption/decryption section 21. In the encrypted authentication information storage area 163′, each piece of key information storage location information, which indicates the location in which a corresponding piece of key information is stored, and each piece of authentication type information, which indicates the attribute of the corresponding piece of key information, are stored as authentication information after encrypted by the storage information encryption/decryption section 21

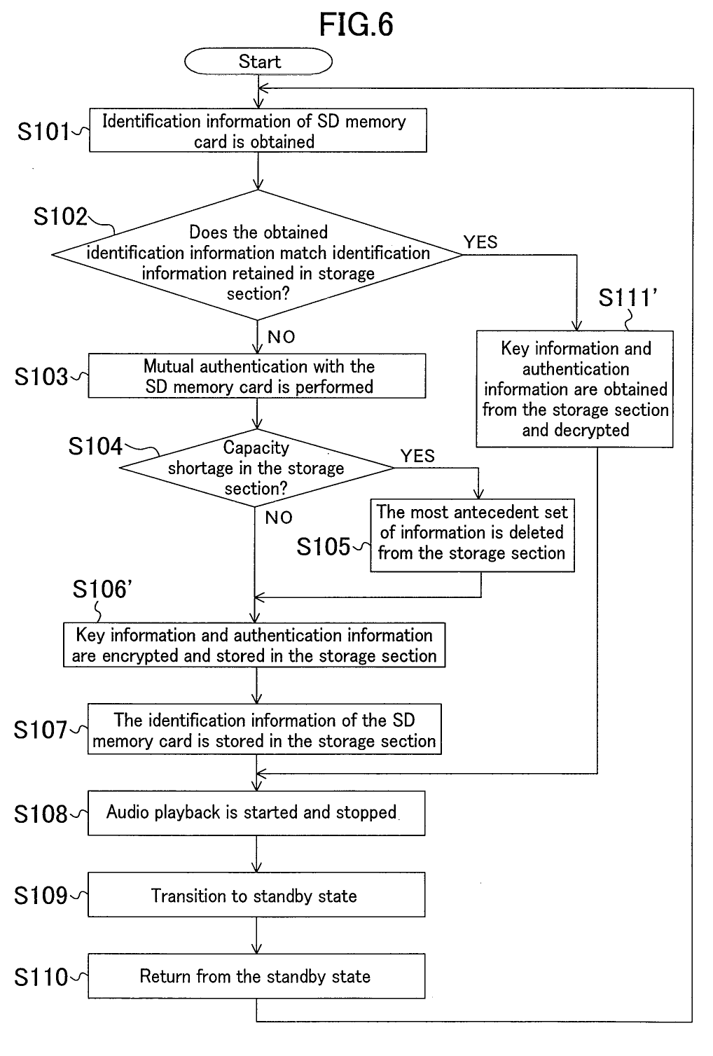

Operation of the media processor 20 will be described below with reference to a flowchart shown in FIG. 6. Steps S101 to S105 are performed in the already described manner.

In Step S106′, the control section 14 stores key information, generated in Step S103 and encrypted by the storage information encryption/decryption section 21, in the encrypted key information storage area 162′ in the storage section 16. The control section 14 also stores key information storage location information that indicates the location of the storage of the key information, and authentication type information that indicates the attribute of the key information in the encrypted authentication information storage area 163′ in the storage section 16 as authentication information after the key information storage location information and the authentication type information are encrypted by the storage information encryption/decryption section 21. Steps S107 to S110 are performed in the already described manner.

In Step S111′, the control section 14 obtains a table number assigned to matching identification information in the identification information storage area 164 in the storage section 16 and obtains encrypted key information and encrypted authentication information corresponding to that table number from the encrypted key information storage area 162′ and the encrypted authentication information storage area 163′. The obtained encrypted key information and the obtained encrypted authentication information are decrypted by the storage information encryption/decryption section 21.

As described above, in the media processor 20 of this embodiment, the key information and the authentication information retained in the storage section 16 are encrypted, thereby increasing the confidentiality of data.

It should be noted that in the scope of the present invention, the recording media are not limited to SD memory cards, and the present invention is not limited to audio contents. When other types of recording media and other kinds of contents are used, the present invention also produces the above-described effects.

What is claimed is:

1. A media processor for reading data from or writing data into a recording medium with which mutual authentication has been performed, the media processor comprising:
an authentication processing section for generating key information of the recording medium and obtaining authentication information of attributes of data stored in the recording medium;
an identification information retrieval section for obtaining identification information of the recording medium;
a storage section for storing various kinds of information; and
a control section for associating the key information, the authentication information, and the identification information with each other to store them in the storage section,
wherein in a case in which the recording medium is changed to another one, if the identification information of the another recording medium matches the identification information stored in the storage section, the key information and the authentication information stored in the storage section are used.

2. The media processor of claim 1, wherein for each of a plurality of recording media, the control section stores the key information, the authentication information, and the identification information in the storage section as one set of information.

3. The media processor of claim 2, wherein the control section deletes in set units the key information, the authentication information and the identification information stored in the storage section.

4. The media processor of claim 3, wherein the control section sequentially deletes the set of the key information, the authentication information and the identification information stored in the storage section from the old one.

5. The media processor of claim 1, further comprising a storage information encryption/decryption section for encrypting the key information, the authentication information, and the identification information and decrypting the encrypted key information, the encrypted authentication information and the encrypted identification information,
wherein the control section associates the encrypted key information, the encrypted authentication information and the encrypted identification information with each other to store them in the storage section.

6. A recording medium control method for reading data from or writing data into a recording medium with which mutual authentication has been performed, the method comprising steps of:
generating key information of the recording medium;
obtaining authentication information of attributes of data stored in the recording medium;
obtaining identification information of the recording medium; and
associating the key information, the authentication information, and the identification information with each other to store them,
wherein in a case in which the recording medium is changed to another one, if the identification information of the another recording medium matches the stored identification information, the stored key information and the stored authentication information are used.
